(19) United States
(12) Patent Application Publication
(10) Pub. No.: US 2014/0236710 A1
(43) Pub. Date: Aug. 21, 2014

(54) ON-LINE ADVERTISING VALUATION

(71) Applicant: Congoo, LLC, Somerville, NJ (US)

(72) Inventor: Ash Nashed, Whitehouse Station, NJ (US)

(73) Assignee: Congoo, LLC, Somerville, NJ (US)

(21) Appl. No.: 14/171,131

(22) Filed: Feb. 3, 2014

Related U.S. Application Data
(60) Provisional application No. 61/766,167, filed on Feb. 19, 2013.

(51) Int. Cl. G06Q 30/02

(52) U.S. Cl. CPC G06Q 30/0246
USPC 705/14.45

(57) ABSTRACT

A method of valuing online advertising locations is disclosed. A clickable ad is served to, an online advertising location and a click total an impression total are obtained for a pre-determined time period. These are used to calculate the click-through-ration (CTR). Optionally, knowing the cost per click of the ad, an effective cost per thousand (eCPM) is also calculated.

Either the CTR or the eCPM, or both, are used as the location score. Location scores are obtained for locations over an advertising domain. Individual location scores are then ranked relative to the average location score for the domain. These ranked scores are used by automated bidding servers to optimize buying on-line advertising locations on a content domain.

### CLAIM OF PRIORITY

This application claims priority to U.S. Ser. No. 61/766,167 filed Feb. 19, 2013, the contents of which are fully incorporated herein by reference.

### FIELD OF THE INVENTION

The invention relates to systems and methods of valuing on-line advertising, and more particularly to monitoring the effectiveness of advertising locations within web-sites and web-pages to provide real-time valuations for assistance in bidding to place advertising in those locations.

### BACKGROUND OF THE INVENTION

On-line advertising has rapidly developed to be a major component of the advertising spending of companies of all sizes. The on-line advertising market has, therefore, become a very sophisticated operation, offering advertisers multiple models for displaying and paying for their advertisements.

The two most popular models of paying for on-line advertisements are the “pay-per-impression” (CPM) and the “pay-per-click” model.

In the CPM model (cost per thousand impressions) advertisers pay for the number of times an advertisement is presented to a view, typically bidding, often in real-time, for display in particular locations of a web-site, including, but not limited to, positions within a page, specific webpages (URLs), subsections of a website, or specific domains or some combination thereof.

The CPM model has many advantages, including, but not limited to, the simplicity of monitoring delivery of the impressions. The CPM model, however, produces no indication of how effective the advertisement impressions are in enticing the viewer into further actions such as, but not limited to, clicking on the ad, interacting with the advertiser's content, buying a product or joining a program or some combination thereof. Different ad locations vary in effectiveness for advertisers for reasons such as, but not limited to, an ad not being easily viewed due to its being placed too far from the center of the featured content on a web page, or on a web page that tends to only be viewed briefly by users such as, for example, a photo page. Other parameters that may impact an ad may include factors such as, but not limited to, the page content, the font, the font size and colors, other display units sharing the space such as videos or other ads, or some combination thereof.

In the PPC model, advertisers typically also buy advertising by bidding, often in real time, for specific locations and time periods. Although, in the PPC model, advertisers only pay when the viewer takes the action of clicking on the advert, the model has several disadvantages.

Those disadvantages include, but are not limited to, the fact that even clicking on an advertisement may only be indicative of curiosity and may not be an indicator of whether or not a sale resulted.

It would be useful to advertisers to know how effective the locations they acquire, or bid for, on a CPM basis are in terms of having viewers interact with the ad, so that they can spend their advertising budget more effectively.

Using metrics obtained from monitoring viewer interactions such as, but not limited to, impressions, clicks, or some combination thereof, on locations that are sold on a per impression basis, the present invention provides such a valuation of an advertising location. This valuation may be available in real-time and may, therefore, assist advertisers in their on-line advertisement purchases.

### Description of the Related Art

The relevant prior art includes:

U.S. Pat. No 7,523,087 issued to Agarwal, et al. on Apr. 21, 2009 entitled “Determining and/or designating better ad information such as ad landing pages” that describes a method of evaluating and comparing the performance (e.g., in terms of selection rates, conversion rates, revenues, profits, etc.) of different ad landing pages by (i) for a given ad or collection of ads, serving the ad with the different ad landing pages (e.g., by rotating through the ad landing pages), and (ii) collecting per ad landing page performance information. An authorized user may be provided with such per ad landing page performance information and may designated one of the ad landing pages to be used in future serves of the ad. An authorized application program may be provided with such ad landing pages performance information and may designate one of the ad landing pages to be used in further serves of the ad using such information.

U.S. Pat. No. 7,031,932 issued to Lipsky, et al. on Apr. 18, 2006 entitled “Dynamically optimizing the presentation of advertising messages” that describes a facility for adjusting the execution of an advertising campaign in which advertising messages are presented using a plurality of advertising alternatives as described. During a first time period, the facility presents advertising messages using each of the advertising alternatives in accordance with an initial allocation for each of the advertising alternatives. Also during the first time period, the facility tracks the performance of the advertising campaign with respect to each of the advertising alternatives. Based upon the tracking during the first time period, the facility attributes a performance score to each of the advertising alternatives for the first time period. The facility compares these scores, and, based upon the comparison, adjusts the allocations for the advertising alternatives so as to increase one or more allocations for advertising alternatives which compare favorably in the comparison, and so as to reduce one or more allocations for advertising alternatives comparing unfavorably in the comparison. The facility then, during a second time period, presents advertising messages using each of the advertising alternatives in accordance with the adjusted allocation for each of the advertising alternatives.

U.S. Pat. No. 7,747,465 issued to Srinivasan, et al. on Jun. 29, 2010 entitled “Determining the effectiveness of internet advertising” that describes a method and system that enables Internet businesses to conduct real-time, online experiments on a sample of transactions to determine marketplace sensitivities. Analysis of the results of the experiments reveal optimal values of key market decision variables such as price, content of banner ads, promotion levels, quantity discount schemes, etc. The experiments may be automatically conducted on an on-going basis, or may be conducted on a periodic basis. The method and system of the present invention preferably allow users to modify the nature of the experiment and the propagation of optimal values. The method and system of the current invention can be used for a pure diagnostic purpose or to automate the setting of key market variables. The dynamic experimentation used by the inventive system reveals the relative stability (or instability) of the networked market within which the business operates. The translation of an optimal value for a key variable (for example, content of a banner ad) to the entire market can be done on a real-time basis.

US Patent Application 20090112976 submitted by K. Hutchinson and published on Apr. 30, 2009 entitled “Method for measuring web traffic” that describes a method for measuring, analyzing and/or reporting web traffic, predetermined events, and/or user activity on one or more web pages utilizing a landing page having code embedded thereon, wherein the program code is structured to deploy at least one portal element onto the landing page. Further, the portal element is structured to display at least one web page therein, while remaining substantially imperceptible at a client interface. Additionally, the program code is structured to detect a source of the web visit, and other predetermined events, including mouse clicks and other navigation activity.

Various implements are known in the art, but fail to address all of the problems solved by the invention described herein. Various embodiments of this invention are illustrated in the accompanying drawings and will be described in more detail herein below.

### SUMMARY OF THE INVENTION

The present invention addresses methods and systems of valuing online advertising locations. Advertising locations may refer to a particular ad position such as, but not limited to, a position within a web page, a specific web page (URL), a subsection, domain, collection of URLs, or grouping of URLs based on similar markers or identifiers such as, but not limited to, belonging to the same publisher over multiple sites, the same ad server or network, or some combination thereof. These valuations may, for instance, be undertaken to estimate how much to bid, or pay, for the use of the locations by an advertiser.

In a preferred embodiment of the present invention, a clickable ad may be inserted in, or served to, a particular advertising location on a webpage. The webpage may, for instance, be available via a communication network, and may be displayed in a browser on one or more viewer, or user, display screens.

The system may then automatically monitor various models of viewer interactivity, such as, but not limited to, advertisement click rates by ad location by all the viewers who visit the webpage within some predetermined time period. Viewer interactivity may be modeled using various techniques that may, for instance, determine snapshots and trends of user interactivity. The system may also automatically monitor an impression total of the advertising location, i.e., the total number of times the ad was presented to viewers, preferably in the same time period.

For example, a click-through rate for the advertising location may be calculated using the number of clicks divided by the number of times an advertisement was presented to viewers, i.e., the number of impressions that occurred during a specific time period. The click-through rate may be the ratio of total clicks to total impressions, and may typically be expressed as the number of clicks that would be expected to be obtained for every one thousand impressions of the on-line advertisement presented in that location.

Knowing how much each click on the clickable ad will cost the advertiser, an effective cost per thousand impressions (eCPM) may be calculated. The eCPM may, for instance, be obtained by multiplying the cost per click by the click through rate expressed as clicks per thousand.

A location score may then be calculated for the particular location, for some location and/or for all locations.

In a preferred embodiment, the location score may simply be based on the click through rate, though in further embodiments the location score may also, or instead be based an effective cost per thousand (eCPM).

In a preferred embodiment, the location score for one location may then be compared to other location scores that may have been obtained during the same time period, for ad locations on the same web-page, the same web-site or sites published by the same publisher. By comparing each location score to an average location score for the page, site or publisher, a user may, for instance, use or cause a software module to be used, that may automatically rank the locations with respect to each other, and may obtain insight as to whether a location has an above or below average location score, and may, therefore, be a cost effective location or may not be a cost effective location for advertisements. The score may, for instance, be delivered as a metric such as, but not limited to, a comparison, an above/below average assessment, as a definite score number, or some combination thereof. The user may then assign a cost value to the scores using public and/or proprietary algorisms or calculations.

Therefore, the present invention succeeds in conferring the following, and others not mentioned, desirable and useful benefits and objectives. It is an object of the present invention to provide a rapid and accurate method of comparing the value of on-line advertisement locations to each other.

It is another object of the present invention to provide location values in a manner that may allow advertisers to optimize their bidding for locations.

Yet another object of the present invention is to provide a means of identifying low performing locations that may be avoided or blacklisted by the advertiser.

Still another object of the present invention is to inform the advertiser when a location is an above-average location and may, therefore, warrant a premium bid.

While a preferred embodiment of the present invention, provides the score, a further preferred embodiment of the invention may complete the loop by monitored each ad served by the recommendations provided by the innovation, and so obtain actual data on the real performance of that particular ad. In such an embodiment, if an advertiser won a bid based on information supplied by the system of the present invention, the advertiser may notify the system of this. The system may then use a method to monitor that ad such as, but not limited to, backend integration of log files, by sending a pixel, or some other marking on the ad, or some combination thereof. The system may then monitor the ad for any interaction such as, but not limited to, a click on or a mouse over the ad. The system may aggregate this information and may, for instance, use it as a feedback loop to help improve and adjust the algorithm that may determine the score of each page.

### BRIEF DESCRIPTION OF THE DRAWINGS

FIG. 1 shows a schematic illustration of an on-line advertisement placed in a web-page in a preferred embodiment of the present invention.

FIG. 2 shows a schematic system diagram of one embodiment of the present invention.

FIG. 3 shows a schematic flow diagram of some of the steps of the present invention.

FIG. 4 shows a schematic of a further preferred embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

In describing the invention, reference may be made to clickable ads displayed in a browser on a display screen. One of ordinary skill in the art will, however, appreciate that such specificity is meant to aid in explaining the invention and that the methods and systems of this invention may be accomplished using any responsive ad in which a user may interact by any suitable means such as, but not limited to, voice input, touch screen input, motion input, or some combination thereof. Similarly, although the term click-through is used to aid understanding, the click-through may be thought of as a specific form of follow through by the user as part of their interaction with the ad.

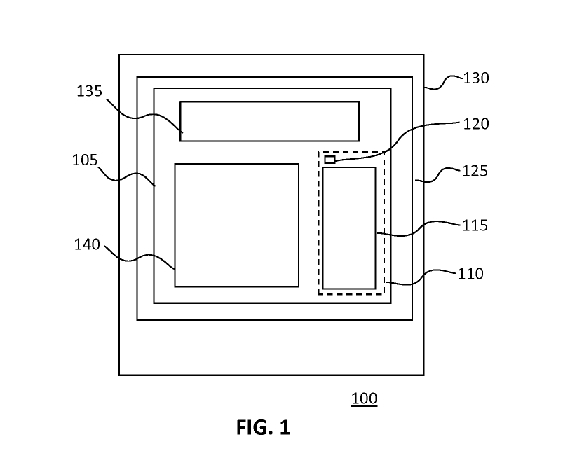

FIG. 1 shows an on-line advertisement placed in a web-page in one embodiment of the present invention.

The method of valuing 100 an online advertising location may be understood by briefly considering how on-line advertisements are placed. FIG. 1 shows a display screen 130 that may be representative of a user surfing a content database such as, but not limited to, the well-known World Wide Web (WWW). The user may, for instance, be using a web-browser 125 to access content stored at a particular uniform resource locator (URL). The content the user may want to see may then be served to them in the form of a hypertext markup language (HTML) that may be transformed by the browser 125 into a graphic layout that may be presented as a webpage 105. The webpage 105 may contain various elements such as, but not limited to, a page banner 135, one or more elements of page content 140 and one or more online advertising locations 110. The online advertising location 110 may, for instance, be used to display a clickable ad 115 or other promotional material. A clickable ad 115 may, for instance, contain graphic material and an embedded URL so that if a user clicks on the ad, their browser may then display a page associated with the advertiser such as, but not limited to, an HTML page from the advertiser's web-site. The clickable ad 115 may also contain, or be associated with, one or more tracking pixels 120. A tracking pixel 120 may, for instance, be associated with a URL for an advertising server, so that each time the web-page containing the tracking pixel 120 is presented to a viewer, a message will be sent to that URL, allowing the number of presentations, or impressions, of the ad to be recorded. The tracking pixel 120 may be an HTML image having only one pixel, as such code is not typically cached by browsers, and the tracking pixel 120 is loaded completely each time the web-page is viewed. This may, for instance, result in a more accurate count of the number of impressions of the ad shown to viewers. The tracking pixel may also, or instead, contain coded instructions such as, but not limited to, a Java Script code that may, for instance, be capable of functions such as, but not limited to, identifying a mouse over, determining if the ad is in view on the user's browser, or some combination thereof.

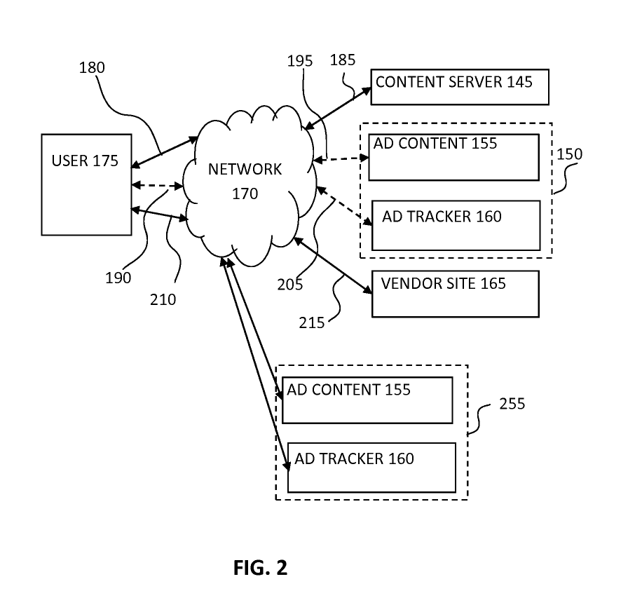

FIG. 2 shows a schematic of one embodiment of the present invention.

A user 175 may access a content server 145 via a user/content interaction 180 that connects the user to a communications network 170, and a content/user interaction 185 that links the communications network 170 to the desired content server 145 containing the desired content. Such access to information is well-known and may, for instance, be implemented using standard protocols and equipment such as, but not limited to, digital computers, TCP/IP protocol addressing and communication layers, packet-switched digital communications networks and HTML content and servers or some combination thereof.

When the content page is delivered from the content server 145 to a user 175, the HTML page may contain links such as, but not limited to, advertising links that may, for instance, be loaded automatically as URL via one or more display/ad interactions 190. These may be relayed via the communications network 170 to an advertising server 150. There may, for instance, be an ad content/display interaction 195 that accesses content from a advertising content server 155. This content may, for instance, be media files such as, but not limited to, logos, ad images and ad related text and may, for instance, be delivered as HTML code that may contain URL or other links to a vendor site server 165. The display/ad interaction 190 may also lead to one or more tracking/display interactions 205. These may, for instance, be notifications that the ad was served, and may contain information concerning the user is was served to such as, but not limited to, the physical location of the computer being used, the type of software running on the computer, or some combination thereof.

In this way the advertising tracker server 160 obtains information every time the ad is available for viewing, and may therefore be used to obtain counts of total impressions of the ad.

When the user 175 interacts with the ad being served by, for instance, clicking on the ad, the user may initiate a user/vendor interaction 210. This in turn may invoke a vendor/user interaction 215 that may result in an HTML web-page being served from the vendor site server 165 to the user. The vendor site server 165 may, therefore, obtain information concerning the viewer activity after clicking on a particular ad.

Other scenario of use may, for instance, include an interaction such as, but not limited to, the following: When the content page may be delivered from the content server to the user, the HTML page may contain links to services such as, but not limited to, a bidder environment, or a real time bidding server that may, for instance, allow multiple advertisers to bid on an ad impression with the highest bidder being the winner, and who gets to deliver the advertisement link to the user. The advertiser's bidding service may, for instance, consult the scoring server for information on how much to bid, if at all, and then bid appropriately. Once a winning advertiser is established, the web-page may continue being downloaded to the user in the regular manner, displaying the winning ad.

One of ordinary skill in the art will, however, appreciate that the arrangement of FIG. 2 is one of many configurations that may be used and that, by having suitable HTML code in or associated with the on-line advertisement, the information concerning the impressions of an ad and the clicks on an ad, may be available to other servers not shown in FIG. 2. An advertising agency, vendor or analyst may, for instance, code adverts so as to make such information available to them as well as, or instead of, to the advertising server 150 and the vendor site server 165.

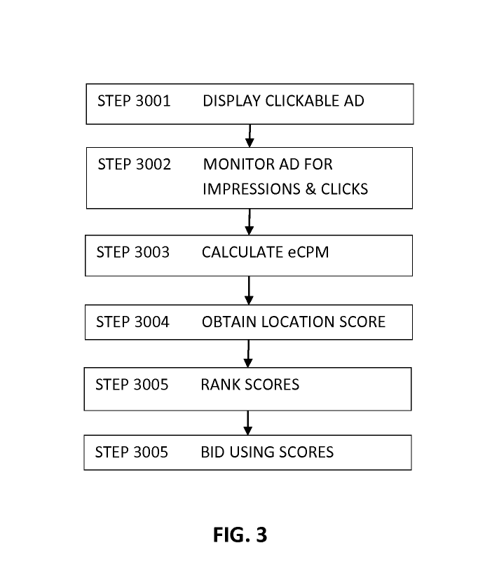

FIG. 3 shows a flow diagram of some of the steps of the present invention.

In a preferred embodiment of the present invention, Step 3001 may display a clickable ad. The clickable ad may, for instance, be an HTML encoded ad that will display text and graphics at a particular location within a particular web-page. The clickable ad may include, or be associated with one or more URLs so that both the number of impressions of the ad, and the number of clicks on the ad may be available to an analyst.

In Step 3002, the ad placed at a location may be monitored in order to count clicks and impressions. An analyst or a suitably programmed software module may, for instance, monitor a click total and an impression total for one or more advertising locations. The impression total, i.e., the total number of impressions in a given, predetermined time, may be obtained for a specific time slot such as, but not limited to, a time of day, a day of the week, a time of the month, a month or season of the year or some combination thereof. Similarly, the click total, i.e., the total number of clicks on an ad in a particular location over a predetermined time, may also be obtained for a particular time slot. Preferably, the time slots for collecting the total clicks and the total impressions are the same, or at least are comparable in that they cover a same length of time, or are taken on the same day of the week or have some such similarity.

In various embodiments of the invention, the predetermined time may be thought of as a test period that may be of varying length for each ad. The test period may, for instance, be a sliding window that may be determined wholly, or in part, by a monitoring algorithm. The system may, for instance use a sliding time window to monitor recent or historical performance, and may use this to extrapolate future behavior.

Having monitored the ad, and obtained a click total and an impression total, an analyst may optionally, in Step 3003, calculate an effective cost per thousand (eCPM).

An analyst, or suitably programmed software module, may, for instance, first calculate a click-through-rate (CTR). A CTR may be a ratio of the number of clicks for a given number of impressions. CTR may be expressed as a percentage or it may be expressed as clicks per thousand impressions. The click total divided by the impression total provides CTR and multiplied by a hundred provides the figure as a percentage. The click total divided by the impression total and multiplied by a thousand give the CTR as clicks-per-thousand. As the cost per click is easily found out, being the cost that a content provider will charge, an effective cost per thousand (eCPM) may be calculated by multiplying the cost per click by the CTR in clicks per thousand.

In Step 3004, a location score is obtained for a particular advertising location. In a preferred embodiment, the location score may simply be the click through ratio for that location.

In a further preferred embodiment of the invention, the location score may also, or instead be based on the eCPM for that location. In more sophisticated embodiments, the location score may modify the click through ratio, or the eCPM, or a combination thereof, by some weighting factor such as, but not limited to, an empirically determined multiplicative weighting factor based on prior evaluations and comparisons of a particular location. Prior tests may have been able to determine that, for instance, although a particular location has a below average click through ratio, or eCPM, a detailed analysis of exactly how consumers came to buy a product, may indicate that, despite the lower click through rate or the lower eCPM, users who saw the ad at that location actually followed through and bought the product in larger quantities than from other locations. That location may, therefore, warrant a multiplicative weighting factor in the location score calculation that reflects this empirical insight. Other predictors that may be used as weighting factors include page types such as, but not limited to, pages with slide presentations, pages with more than a certain number of pictures, pages with user content, or some combination thereof. Other predictors may be based on factors such as, but not limited to, current user session depth.

In Step 3005, having obtained location scores for a number of locations, the locations may be ranked against each other and ordered into a table reflecting their relative rank.

Ranking the advertising locations may be done over domains such as, but not limited to, locations within a web-page, locations within a web-site, locations within a publisher's products, or some combination thereof.

An average value of the location scores may be obtained over the domain of locations. The average value may, for instance, be a mathematical construct such as, but not limited to, an arithmetic average, a mean value, a median value, or some combination thereof. Locations may then be classified as simply above or below average, or grouped into categories or percentiles such as, but not limited to, within 5% of average, within 10% above average, more than 10% above average, or some similar categories. Grouping location scores into categories may make using the location scores simpler, as the same action may be taken on all scores within a category, rather than having to make an individual decision for each actual location score.

In step 3005, the location scores, preferably the ranked location scores may then be used in bidding for, or buying, advertising locations.

The ranked location scores may, for instance, be used to black-list all advertising locations that are below some value for some period of time. For instance, an automatic bidding system may be programmed to ignore, or black-list, all locations whose location scores are ranked as below average for the rest of the day, or until the web-page content is refreshed. Other criteria may also or instead be used such as, but not limited to, black-listing advertising locations for the remainder of a day if the location score is below 25% of a mean or an average of a particular location domain.

The location scores may, for instance, be made available to a bidding server in real-time. A properly programed bidding server may then automatically make bids that may help an advertiser to optimize their impact using a pre-set advertising budget. This may, for instance, be achieved by using the location scores to acquire cost effective advertising locations.

In a further preferred embodiment of the invention, Step 3002 of monitoring ads for click totals and impression totals may be carried out by examining log files of one or more servers, rather than by tagging the on-line advertisements. The log files of an advertiser may, for instance, be parsed for occurrences of requests arriving from specific advertising locations to obtain an estimate of total clicks. Similarly, adverting log files may be automatically parsed to identify instances in which the particular ad was served to obtain a number for the total impressions during a specific period. The click-through-rate and or the eCPM may then be calculated as previously described.

In yet a further preferred embodiment of the invention, a dictionary may be created of correlations between HTML code phrases and the location score of associated advertising sites. Correlations of code phrases and good or bad advertising location scores may then be used in estimating the location scores of other online advertising locations without having to measure clicks and impressions, or such correlations may be used to weight the click-through-ratios or the eCPM values when calculating location scores.

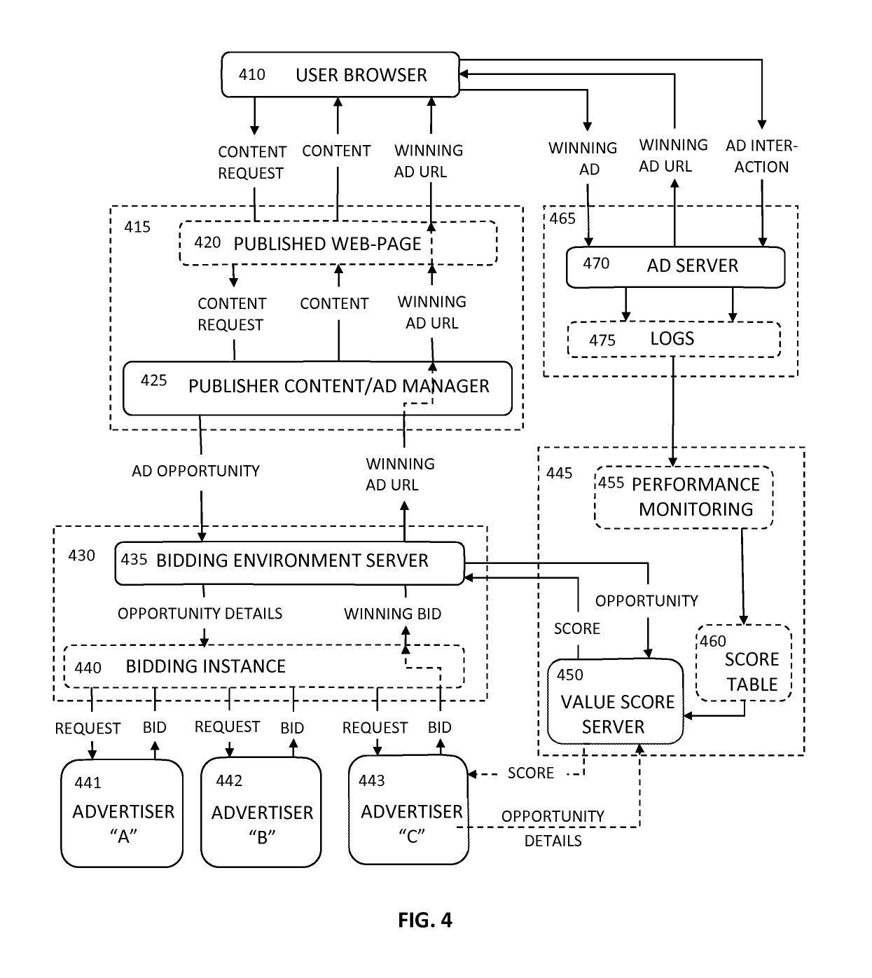

FIG. 4 shows a schematic of a further preferred embodiment of the present invention.

A User browser 410 may send a content request to a published web-page 420 that may, for instance, be part of a publisher platform 415. The User browser 410 may then receive content and an advertising URL from the published web-page 420 and an advertising URL. The content may be displayed immediately on the user browser, while the browser may use the ad URL to obtain an ad from an ad server 470 residing on an ad serving platform 465.

When the published web-page 420 receives the “content request”, it may additionally send a “content request” on to the publisher content and ad manager 425, also part of the publisher platform 415. The publisher content and ad manager 425 may then supply a premium ad URL form its own library of ad URLs, or it may send an “ad opportunity” on to a bidding environment server 435 that may be part of a bidding environment 430.

In a preferred embodiment, the “ad opportunity” may, for instance, be a digital electronic message that may be commercially encrypted and may contain information such as, but not limited to, a publication ID, a browser ID, location of the user, the publication page and type of page, cookie data that may be obtained from the user browser, a browser URL, a publisher URL, or some combination thereof.

The bidding environment server 435 may enrich the “ad opportunity” either by using data and statistics in its own databases, or by sending the “ad opportunity” to the value score server 450 that may be part of the value score platform 445 to obtain a “score”, or a combination thereof. The “value score” may, for instance, pertain to a URL, the domain, the sub-domain or a group to which the domain belongs, or some combination thereof.

The bidding environment server 435 may then create a bidding instance 440. The bidding instance 440 may, for instance, be a limited time auction in which the enhanced “ad opportunity” may be sent as a “request” to one or more advertisers, 441, 442 or 443.

The advertisers may then respond to the “request” with a “bid” that may be a price they are willing to pay for the impression offered by the “ad opportunity”. This price may, for instance, be take the form of an electronic commitment to pay a monitory amount for the “ad opportunity”, if the bid is successful. The winning bid may be the highest price bid by one of the advertisers within the time limit, or time slot set, for the auction.

The URL of the winning bid may then be passed on via the bidding instance 440 to the bidding environment server 435 and then on to the publisher content and ad manager 425 from where it may be sent to the User browser 410 by way of the published web-page 420.

As detailed above, the “winning ad URL” may then be sent from the User browser 410 to the ad server 470 so that the ad server 470 may send the “winning ad” to the User browser 410 for display in the appropriate location along with the “content” delivered from the published web-page 420.

The ad server 470 may also monitor any “ad interaction”, i.e., any action the user may be perceived to take on their browser on being shown the ad, i.e., on the occurrence of an ad impression to the user. The “ad interaction” may be some describable user interaction with the displayed ad such as, but not limited to, clicking on the ad, mousing over the ad, touching the ad, moving the ad, saving or storing the ad or its URL, or some combination thereof.

The ad server 470 may store records of the ads served and “ad interactions” associated with the ads served on the ad server logs 475 that may also be a part of the ad serving platform 465. The data logged by the ad server logs 475 may, for instance, include data such as, but not limited to, the page, the user, the impression and the interaction details, or some combination thereof.

The performance monitoring module 455 may contain a performance monitoring module 455 that may access the ad server logs 475 to obtain the data and then use the data to access the performance of ad sites, as detailed above. The data in the ad server logs 475 may be accessed or downloaded to the performance monitoring module 455 in real time, as a batch process at predetermined times or data quantities, or some combination thereof.

The performance monitoring module 455 may send the monitored performance of ad sites on to a score table module 460 that may also be a part of the value scoring platform 445. The score table module 460 may, for instance, contain one or more tables of statistics concerning the performance of ad sites as a function of variables such as, but not limited to, time of day the ad was placed, the day of the week, the day of the month, the session depth, the page types that may include, but is not limited to, pages with slide presentations, pages with more than a certain number of pictures, pages with user content, or some combination thereof.

The score table module 460 may, for instance, aggregate all available performance data that happened in the last X minute time-frame, with the time-frame being determined by, for instance, a value scoring algorithm. The score table module 460 may, for instance, assign and store value scores for each type of ad location that it is programmed for, such as, but not limited to, scores for URLs, sections, domains, page groups, domain groups or some combination thereof.

In a preferred embodiment, the score table module 460 may also use score calculated in the past, such as, but not limited to, score calculated in the previous time cycle, as predictors for scores in the current or next time cycle, or some combination thereof.

In a further preferred embodiment of the invention, the value score server 450 may also, or instead, obtain “opportunity details” for an advertiser such as advertiser “C” 443. The value score server 450 may then use the “opportunity details” to prove advertiser “C” 443 with a “value score” that the advertiser “C” 443 may use in determining what to bid on that ad opportunity.

Although this invention has been described with a certain degree of particularity, it is to be understood that the present disclosure has been made only by way of illustration and that numerous changes in the details of construction and arrangement of parts may be resorted to without departing from the spirit and the scope of the invention.

In particular, although much of the description has been in terms of impressions, clicks and eCPM, one of ordinary skill in the art will appreciate that the invention may also, or instead be implemented using any suitable metrics measured over any suitable quantities.

What is claimed:

1. A method of valuing an advertising location, comprising:
using a programmed digital processor to perform functions comprising:
displaying, using a programmed digital processer, a responsive ad in said advertising location on a digital display screen;
automatically monitoring, using said programmed digital processer, a response total and an impression total of said advertising location;
calculating a follow-through rate for said advertising location, said follow-through rate being the ratio of responses to impressions;
providing a location score for said advertising location, said location score comprising said follow-through rate.

2. The method of claim 1 further comprising performing a function of supplying said location score to a bidding environment server in real-time, and wherein said bidding environment server prepares and distributes details of bid opportunity to one or more advertiser's servers.

3. The method of claim 1 further comprising performing a function of supplying said location score to an advertiser's server in real-time, and wherein said advertising server is programmed to automatically bid an amount for said advertising location based on said location score.

4. The method of claim 1 further comprising performing a function of calculating an effective cost per impression as a cost of said responsive ad multiplied by said follow-through rate; and wherein said location score further comprises said effective cost per impression.

5. The method of claim 1, wherein:
said responsive ad is a clickable ad, and wherein said clickable ad is displayed in a browser on a display screen;
said response total is a click total;
and further comprising calculating a click-through rate for said advertising location, said click-through rate being the number of clicks per one thousand impressions wherein said location score comprises said click-through rate.

6. The method of claim 5 further comprising performing a function of calculating an effective cost per thousand impressions (eCPM) as a cost of said responsive ad multiplied by said click-through rate; and wherein said location score further comprises said effective cost per impression.

7. The method of claim 1 wherein said location score is calculated for a specific time of day.

8. The method of claim 1 wherein said location score is provided for a plurality of advertising locations within a web-site.

9. The method of claim 8 further comprising performing a function of calculating an arithmetic average value of said location scores, and wherein one of said location scores is ranked as above-average if its value exceeds said average value, and one of said location scores is a ranked as below-average if it value is less then said average value.

10. The method of claim 8 further comprising performing a function of blacklisting an advertising location for a predetermined amount of time if said location score is below a predetermined value.

11. The method of claim 10, wherein said advertising location is black-listed for the remainder of a day if said location score is below 25% of a mean of said plurality of location scores for said web-site.

12. The method of claim 8 wherein said advertiser's server automatically makes no bid on one of said advertising locations having said location score less than an average value of said plurality of location scores.

13. The method of claim 1 wherein the function of monitoring said response total and said impression total further comprises automatic analysis of one or more log files of an advertising server.

14. The method of claim 1 wherein said location score further comprises multiplication by a weighting factor, said weighting factor comprising analysis of previous location scores for said advertising location.

15. The method of claim 1 further comprising performing a function of providing said location score for a plurality of advertising locations within a level selected from one of a URL, a subdomain, a domain and a publisher.

16. The method of claim 1 further comprising performing a function of creating a dictionary of correlations between HTML code phrases and said location value, and using said dictionary to estimate a location value base on HTML code associated with said advertising location.

17. The method of claim 1 further comprising performing a function of providing said location score for a plurality of advertising locations within one of a web-site, a URL, a subsection of a website, a domain and a collection of URLs, or some combination thereof.

18. The method of claim 1 wherein providing said location score further comprises multiplication by a weighting factor, said weighting factor comprising analysis of viewer demographics, content viewing history or purchase history.

19. The method of claim 1 wherein providing said location score further comprises multiplication by a weighting factor, said weighting factor comprising analysis of the number of impressions already viewed by the viewer on said web-site.
